(19) United States
(12) Patent Application Publication
(10) Pub. No.: US 2004/0258658 A1
(43) Pub. Date: Dec. 23, 2004

(54) Chemical composite attractant of premolting female blue crabs

(76) Inventors: James Hugh Reho, Greenville, NC (US); William Gabriel Dough, Manteo, NC (US)

Correspondence Address: MYERS BIGEL SIBLEY & SAJOVEC, PO BOX 37428, RALEIGH, NC, 27627, US

(21) Appl. No.: 10/782,460

(22) Filed: Feb. 19, 2004

Related U.S. Application Data
(60) Provisional application No. 60/448,813, filed on Feb. 20, 2003.

(51) Int. Cl. A01N 25/00; A22C 29/02

(52) U.S. Cl. 424/84

(57) ABSTRACT

The present invention provides compositions and methods for attracting premolting female blue crabs to traps for the purpose of obtaining soft shell crabs

### RELATED APPLICATIONS

This application claims the benefit, under 35 U.S.C. § 119(e), of U.S. provisional application Ser. No. 60/448,813, filed Feb. 20, 2003, the entire contents of which are incorporated by reference herein.

### FIELD OF THE INVENTION

The present invention provides a composition for attracting female blue crabs to a trap to obtain soft-shelled crabs, and methods of use of the composition.

### BACKGROUND OF THE INVENTION

In the soft-shell crab industry, a commercial soft-shell crabber must bait and recover sexually mature male blue crabs (Callinectes sapidus) known as “jimmies,” which are then placed in special peeler pots to serve as attractants for luring female “peeler” crabs (precursors to soft-shell crabs) into the peeler pots from which they are harvested. The peeler crabs are attracted to the jimmies due to a desire to mate during their pubescent molt, at which time they are “soft-shelled” crabs. Not all jimmies are successful attractants of peeler crabs.

There is a need in the art for a composition that can serve as a sexual attractant of peeler crabs, to replace the jimmies in the collection of soft-shelled crabs. The time and resources to bait and catch jimmies, which may or may not be effective attractants, would be eliminated if a quality-controlled attractant composition was available to commercial soft-shell crabbers.

The present invention overcomes the disadvantages in the art by providing a composition for attracting female blue crabs to crab pots for collection of soft-shelled crabs.

### SUMMARY OF THE INVENTION

The present invention provides a composition comprising a mixture of components, wherein said components comprise:

eicosane/eicosanoids

docasane/docosanoids

tetracosane/tetracosanoids

nonacosane

9-octyl-heptadecane

pentatriacontane

hexatriacontane

19-norpregn-4-ene-3,20-dione

urs-12-en-28-ol

1-tetradeacanamine

4,4-dimethylcholestan-3-ol

nonadecenes

nonadecanes

1,3-diethyl urea

androst-8-en-11-one

3-benzoquinolinedione

asparagine

urethane

pentacosane/pentacosanoids

hexacosane/hexacosanoids

heneicosane/heneicosanoids

tricosane

octacosane

1-hexadecene

1,3-dimethyl-8-purin-2,6-dione

imidazoloids

morphinanones

docosenes

heneicosenes

epinephrine

traicontane

quinoline

pyrazine

pregnadiene

4,4-diemthylandrost-5-en-3.beta.ol or

nortriptyline

or any combination thereof.

Also provided in this invention is a method of attracting female blue crabs to a trap, comprising introducing into said trap an amount of the composition of this invention effective in attracting female blue crabs into the trap.

### DETAILED DESCRIPTION OF THE INVENTION

As used herein, “a,” “an” and “the” can mean one or more than one, depending on the context in which it is used. For example, “a” blue crab can mean one blue crab or multiple blue crabs.

The present invention is based on the discovery that a male blue crab (jimmy) can be replaced with a chemical composition that can be used to attract female blue crabs (peelers) to a crab pot, for the purpose of collecting soft-shelled crabs for the food industry. The blue crab of this invention can be any crab of the genus Callinectes, including the species sapidus and all subspecies.

Specifically, the present invention provides a composition comprising a mixture of components, wherein said components comprise: eicosane/eicosanoids, docasane/docosanoids, tetracosane/tetracosanoids, nonacosane, 9-octyl-heptadecane, pentatriacontane, hexatriacontane, 19-norpregn-4-ene-3,20-dione, urs-12-en-28-ol, 1-tetradecanamine, 4,4-dimethylcholestan-3-ol, nonadecenes, nonadecanes, 1,3-diethyl urea, androst-8-en-1-one, 3-benzoquinolinedione, asparagine, urethane, pentacosane/pentacosanoids, hexacosane/hexacosanoids, heneicosane/heneicosanoids, tricosane, octacosane, 1-hexadecene, 1,3-dimethyl-8-purin-2,6-dione, imidazoloids, morphinanones, docosenes, heneicosenes, epinephrine, traicontane, quinoline, pyrazine, pregnadiene, 4,4-diemthylandrost-5-en-3.beta.ol, or nortriptyline and/or any combination thereof. The present invention can further comprise any functioning pheromone present in the testicular and/or intestinal systems of the male C. sapidus.

The components of the composition of this invention can be present in any combination and in any ratio relative to one another. The components can be purified from a natural source or synthesized according to methods well known in the art. In one embodiment, the components of this composition can be obtained from intestinal and/or testicular tissues of a male blue crab.

The composition of the present invention can be combined with and/or contained in various materials to be used in the methods of this invention. For example, materials of this invention can include, but are not limited to, gauze, cotton, mesh wire, capsules, pellets, organic matrices, permeable plastic containers, biodegradable containers, gel-tabs, mineral matrix bindings, polymer matrices, generalized binding matrices, gelatin matrices, sponges and the like.

In one embodiment, the composition of this invention can be combined with and/or contained in a material that will allow slow release of the composition into an aqueous environment over time. For example, the composition of this invention can be combined with or contained in a mineral matrix such as a matrix comprising calcium carbonate, magnesium carbonate, magnesium sulfate, and/or other minerals, or a matrix comprising a polymer. The composition could also be present, for example, in a sealable permeable hollow apparatus, a time-releasing sponge like substance, a capsule and/or a gel-tab. These containers or matrices can be constructed such that the composition leaks out or diffuses slowly over time in an aqueous environment and/or the containers or matrices of this invention can comprise a biodegradable material that degrades over time in an aqueous solution, thereby releasing the composition into the surrounding environment.

The composition of this invention can be combined with one or more of any common preservative, such as sodium benzoate, and such preservatives are well known in the art.

In one embodiment of this invention, the composition can comprise, consist essentially of, and/or consist of a homogeneous emulsion of testicular material from male crabs, which can be dispersed in gelatin. This composition can include a preservative of this invention, such as sodium benzoate.

The compositions of this invention can be used in a method of attracting female blue crabs to a trap, comprising introducing into said trap an amount of the composition of claim 1 effective in attracting female blue crabs into the trap. In one embodiment, the female blue crabs attracted to the trap are pre-molting (V-bottom) female blue crabs.

An effective amount can be determined according to the methods provided herein and according to protocols known in the art. For example, an effective amount of the composition of this invention is that amount of composition that attracts the same number of female crabs to a peeler pot as would be attracted to the peeler pot in the same time period if a normally-functioning mature jimmy was present in the pot. The crab pot of this invention is a “peeler pot” or any pot used for the capture of crabs.

### EXAMPLES

I. Methods of Producing the Composition from Intestinal and Testicular Tissue of Male Blue Crabs

The tissue composition was obtained through the stirring and/or sonication for a given time (˜1 hr) of male C. sapidus intestinal and testicular material in toluene. The intestinal and testicular material had been isolated through dissection and in most cases stored frozen for a time but in some cases prepared in toluene directly upon dissection. The resultant solution (any remaining solids were removed) was then used for both the GCMS analysis as well as in behavioral studies that involved dropping the solution into a chamber. Such solutions were also used in the behavior study that involved the cotton ball.

II. Testing of Composition

The present invention demonstrates the ability of an inanimate chemical composition to attract pre-molting (V-bottomed) female blue crabs (e.g., Callinectes sapidus) and the ability of such composition to elicit in these females a sexual response such as is issued in response to a male (jimmy) blue crab (e.g., C. sapidus). These behavior studies involved the use of choice boxes, in which a pre-molting female crab is placed in a large chamber with a natural gravel flooring and filled with seawater at the proper temperature and salinity appropriate for mating. From this main compartment of the choice box, the female is free to travel to other compartments that are separated by permeable walls and/or mesh from the main compartment. Some studies are done in minimal lighting and all with strict silence and absence of movement from the experimenter so as not to startle/inhibit the female crab.

In one successful study, an aqueous solution of intestinal and testicular material from male C. sapidus specimens was soaked into cotton balls and was placed into a wire mesh container and placed into one smaller compartment of a choice chamber. Foodstuff was present as a “blank” in another small compartment. The pre-molting female C. sapidus approached the compartment containing the soaked cottonball, not opting for the food, and exhibited sexual interest in the composite (i.e., backing up toward the entrance of the chamber housing the composite). Other behavior studies using other lures have also been conducted.

Similar behavior from pre-molting females has been observed in response to the presence of male C. sapidus and never in response to foodstuffs, or other “blanks.” This positive sexual response of the pre-molting female C. sapidus was elicited also in response to drops of the aqueous solution of intestinal and testicular material being added to one of the small compartments of the choice box. It is noted that pre-molting females typically don't feed until after their molt, so the only reason they would be attracted to a trap at all is for the purpose of mating.

In addition to the above choice box testings, a field test was performed in Roanoke sound in which five standard peeler pots (i.e., pots commonly used for the capture of pre-molting female C. sapidus through use of a jimmy crab) were baited with variants of our composite preparations. The composites used involved previously frozen testicular material from male C. sapidus specimens which had been dispersed in a gelatin medium and the gelatin allowed to harden. Four of the five pots were baited with blanks, in which the crab material had been allowed to rot (thus serving as ‘food’ rather than as a functioning pheromone). Three of these four pots were recovered empty while one had a single pre-molting female C. sapidus present. The fifth pot, baited with non-rotten testicular material (the material preserved through refrigeration and the addition of sodium benzoate upon formation of the gelatin mold) was recovered with eighteen pre-molting female crabs present, thus underscoring the ability of the composition of this invention to selectively lure pre-molting female crabs in the field when used as a replacement for jimmy crabs in traditional peeler pots.

These experiments thus confirm the use of the chemical composites of this invention in attracting pre-molting female crabs. Presently, commercial crabbers use actual male crabs in order to attract pre-molting females in commercial “soft-crabbing,” as these pre-molting females are held in shedder tanks after capture until they become “soft” and are then sold commercially. These experiments evidence the ability of other materials, such as the compositions of this invention, rather than the live male C. sapidus crab to be effective toward this end.

III. Characterization of Composition

The chemical composition eliciting this response was comprised of male C. sapidus intestines and testes prepared as described above. This tissue composite was analyzed using a HP5970 GCMS (Gas Chromatograph-Mass Spectrometer) run in splitless mode. Studies were done using toluene, benzene, methanol, and other solvents. Such studies confirmed the presence of several chemicals in the intestinal/testicular solution which have a high probability of functioning as pheromones, including but not limited to the components listed herein in the compositions of this invention.

It is understood that the foregoing detailed description and Examples are given merely by way of illustration and that modifications and variations may be made therein without departing from the spirit and scope of the invention.

What is claimed is:

1. A composition comprising a mixture of components, wherein said components comprise:
eicosane/eicosanoids
docasane/docosanoids
tetracosane/tetracosanoids
nonacosane
9-octyl-heptadecane
pentatriacontane
hexatriacontane
19-norpregn-4-ene-3,20-dione
urs-12-en-28-ol
1-tetradeacanamine
4,4-dimethylcholestan-3-ol
nonadecenes
nonadecanes
1,3-diethyl urea
androst-8-en-1-one
3-benzoquinolinedione
asparagine
urethane
pentacosane/pentacosanoids
hexacosane/hexacosanoids
heneicosane/heneicosanoids
tricosane
octacosane
1-hexadecene
1,3-dimethyl-8-purin-2,6-dione
imidazoloids
morphinanones
docosenes
heneicosenes
epinephrine
traicontane
quinoline
pyrazine
pregnadiene
4,4-diemthylandrost-5-en-3.beta.ol or
nortriptyline
or any combination thereof.

2. The composition of claim 1, wherein the composition is produced from intestinal and testicular tissue of the male blue crab, Callinectes sapidus.

3. The composition of claim 1, combined with a material that allows for slow release of the composition into an aqueous solution over time.

4. A method of attracting female blue crabs to a trap, comprising introducing into said trap an amount of the composition of claim 1 effective in attracting female blue crabs into the trap.
